(19) United States
(12) Patent Application Publication
(10) Pub. No.: US 2007/0054232 A1
(43) Pub. Date: Mar. 8, 2007

(54) Adapter for a medical handpiece, medical handpiece and medical supply unit

(76) Inventor: Stephan Rauchenzauner, Salzburg (AT)

Correspondence Address: Matthew K. Ryan, Esq.;FROMMER LAWRENCE & HAUG LLP, 745 Fifth Avenue, New York, NY, 10151, US

(21) Appl. No.: 11/502,693

(22) Filed: Aug. 11, 2006

(30) Foreign Application Priority Data
Sep. 6, 2005 (EP) 05019327.5

(51) Int. Cl. A61C 1/00

(52) U.S. Cl. 433/29

(57) ABSTRACT

The present invention relates to an adapter for a medical handpiece and to a medical supply unit, which comprise a circuit that is designed such that an electrical power supply provided by a supply unit is checked and automatically prepared such that it can be supplied to any desired light source of a medical handpiece for operating the light source.

The present invention relates to an adapter for a medical handpiece, by way of which adapter the power suppliable by a power supply unit can be fed to the handpiece, and to a medical handpiece comprising a light source and an associated light-source circuit, and to a medical supply unit to which at least one medical handpiece is connectable. The invention further relates to a method for preparing the power supplied by a supply unit for a light source or for a light-source circuit of a medical handpiece.

Medical handpieces, and in particular handpieces for oral medicine or dentistry, for which the present invention is of particular significance, regularly comprise light sources and an associated light-source circuit. The light sources can serve different purposes; in particular the light sources are regularly used for illumination, in the dental sphere for example for illuminating the oral region of a patient, which region is to be treated or worked on. However, the light sources can also be used for other purposes, in particular treatment purposes, wherein as an example a light source for the polymerisation of light-curing plastics is mentioned, which light source is in particular also used in the field of dentistry.

To be supplied with power the handpieces usually have to be connected to a supply unit, wherein the supply unit is preferably designed such that handpieces of different types can be connected to the supply unit and preferably also to essentially identical connection pieces of the supply unit.

This is associated with a problem in that the different light sources of the medical handpiece can be designed in a host of different ways and thus require different power supplies. For example, when a LED is used as a light source, the correct polarity of the contacts must be ensured.

From US 2004/0166464 A1 for example an adapter is known that can be connected to a handpiece, wherein the handpiece is for example equipped with a LED light source. According to this printed publication an adapter is provided that can be manually switched to and fro between two states so as to match the polarity of the electrical power to the polarity required to supply the LED.

Starting from this state of the art it is an object of the present invention to provide a system that makes it possible to use different handpieces with different light sources, and to connect them to a supply unit, while preventing incorrect operation by the user.

This object is met by an adapter according to claim 1, a medical handpiece according to claim 7, a medical supply unit according to claim 16, and a method according to claim 23. Claims 2 to 6 relate to particularly advantageous embodiments of the adapter according to the invention according to claim 1; claims 8 to 15 relate to particularly advantageous embodiments of the medical handpiece according to the invention according to claim 7; claims 17 to 22 relate to particularly preferred embodiments of the medical supply unit according to the invention according to claim 16; while claims 24 and 25 relate to particularly advantageous embodiments of the method according to the invention according to claim 23.

An adapter, a medical handpiece or a medical supply unit according to the invention comprise a circuit that is connected to an output circuit device and an input circuit device, wherein the circuit is designed such that based on the signals provided by the output circuit device said circuit prepares the power supply in such a way that power with the required characteristics can be supplied to a light-source circuit of a light source of a handpiece, wherein the required characteristics of the power supply among other things relate to both the voltage and the current intensity or amperage, and in particular also to any required polarity of the power supply, which polarity is in particular required where a LED is used as a light source, which is increasingly frequently the case as a result of the advantageous characteristics of LEDs both in relation to their efficiency and in relation to their radiation characteristics. Polarity is for example also important in the case of gas discharge lamps, while in the case of incandescent lamps polarity is not required as a rule because incandescent lamps can usually be operated with direct current of any polarity or with alternating current. Nonetheless even in the case of incandescent lamps as light sources it may be also desirable to provide specific polarity or a specific type of power supply, be it direct current or alternating current. Preferably the circuit of an inventive adapter of a medical handpiece or a medical supply unit is designed such that not only the polarity but also the type of the illumination means or instrument are detectable, i.e. it is for example detectable whether the illumination means is a LED, an incandescent bulb, a gas discharge lamp or some other illumination means, or whether the instrument used is a specific special instrument. Preferably, detection takes place irrespective of whether a voltage source or a current source is used.

In this context it should also be pointed out that the term “medical supply unit” in the sense of this invention can be interpreted in the widest possible sense: such a medical supply unit can be a medical supply unit, a dental supply unit such as for example a dentist's chair, but the medical supply unit in the sense of this invention can also be a power supply unit such as for example an outlet to which directly or indirectly, i.e. by way of further intermediate elements such as adapters or the like, a handpiece with a light source can be connected.

Furthermore, at this stage it should be pointed out that an “adapter” in the sense of the invention typically refers to relatively small elements, which in particular are directly connected to a handpiece and which in particular in their form, diameter and their dimensions match the handpiece; however, the term “adapter” in the sense of the invention also covers the widest possible definitions, including any desirable intermediate element or intermediate component that can be arranged at any position between a handpiece on the one hand and a supply unit or power supply on the other hand. Furthermore, the adapter in the sense of the invention can be a component which apart from the functions according to the invention, which functions have been described, also has other functions.

A system according to the invention is in particular associated with an advantage in that by way of the circuit according to the invention, and by using the input circuit device and the output circuit device according to the invention, automatically both the power provided, and the power required, by the light source are checked and detected, after which automatically, by means of the circuit, the power supply is prepared such that the overall system functions, in particular that power with the required characteristics is supplied to the light source and to the light-source circuit, without the user having to initiate any steps or having to select any settings, so that the user, i.e. the physician or dentist, can fully concentrate on the actual task at hand. This also ensures the avoidance of any damage to the light source or to the light-source circuit or to other components, which damage can for example occur with connection to an “incorrect” power supply.

Furthermore, the invention is associated with an advantage in that an existing system, which for example comprises a medical supply unit and a specific number of medical handpieces, can at some later point in time be supplemented with additional handpieces without there being any need to check whether the power supply lines of the supply unit match the additional handpiece(s), wherein it should be noted that in some instances it can be difficult to verify correct cabling of the medical supply unit, especially for a user of the system who is not familiar with the electrotechnical details of the system, which fact emphasises the important of the invention in practical application.

An adapter according to the present invention is associated with an advantage in that it can be used essentially independently of the plurality of medical handpieces on the one hand, and of the medical supply unit on the other hand, and can basically be inserted between the supply unit and the medical handpiece. In the case of a medical handpiece according to the present invention such an adapter is not necessary, which is advantageous in particular if, for example, an additional medical handpiece according to the invention is added to an existing system, because in this case there is no need to check the compatibility of the power supply. A medical supply unit according to the present invention is associated with an advantage in that already on this base unit all the devices are present that make possible the connection of essentially any desired handpieces with light sources, without the handpiece itself having to be equipped according to the invention and/or without an additional adapter having to be provided. In particular when a new overall system is purchased a medical supply unit according to the invention is very attractive because any subsequent elements, in particular any additional medical handpieces, do not require further measures.

In the case of devices according to the present invention various modules or elements can be used, in particular so-called reverse polarity protection circuits can be used that comprise a diode, mostly however more than one diode, and if need be comprise additional components. A so-called bridge circuit of diodes is possible, where the diodes are arranged and connected such that their direction of flow and direction of blockage is utilised such that the power supplied is transmitted onward with a specified polarity direction, irrespective of the input polarity. Such reverse polarity protection circuits are in particular of importance when a LED is used as the light source.

A circuit that is used in the adapter, the medical handpiece or the supply unit according to the invention preferably comprises a logic circuit, wherein the logic circuit can be implemented either by software and if need be by a corresponding microprocessor, or by means of logic modules, or by means of a combination of software and logic modules. In a preferred embodiment such a circuit also comprises a DC/DC converter, e.g. a so-called step-up converter, in order to, if need be, adapt the power provided to match the desired characteristics.

The devices according to the invention further comprise an output circuit device that detects the light source to be connected and the light-source circuit, for example also the polarity of a LED. In a preferred embodiment such detection in particular takes place by means of one or several current voltage readings, by means of which the interesting characteristics, for example the polarity, of the connected light source are identifiable.

For this purpose preferably, for example, a method is used that comprises the following steps: applying a specified voltage or a specified current, preferably in a range in which the light source, for example the LED, is not yet in its operating state, i.e. is not yet illuminated or radiating, and measuring either the current that flows at the specified voltage, or measuring the voltage drop at the light source at the specified current. The result of such measuring is used to characterise the light source, wherein measuring for example in the case of a LED indicates a particular current value and voltage value that is located on the current-voltage characteristic curve that applies to the LED. If this measuring point is in a region of the characteristic curve which characterises the direction of flow, the polarity is correct; however, if this point is on the characteristic curve associated with the direction of blockage, the polarity of the power provided must be reversed in relation to the polarity of the power that is supplied during the measuring process.

Preferably, a characteristic curve of at least one LED is stored in a microprocessor, wherein in the microprocessor by means of software support also the comparison between the measuring results and the characteristic curve, of which there is at least one, is made.

Of course, as an alternative, additionally, or in part, a hardware-based logic can be implemented by means of logic modules.

Apart from setting the polarity, which may be required, of a light source or of a light-source circuit, which setting can preferably take place by way of an electronic circuit but also by way of any other desired means, for example by way of a fixed regulator or an integrated circuit regulator, preparation of the power supply can take place by means of the electronic circuit or by means of integrated circuits that regulate the voltage or the current to the value that is characteristic for the light source.

For example at a desired constant light output, current values can be held constant, or they can be changed for example if a change in light output is desired. In a special embodiment of the devices according to the invention so-called step-up converters can be used to provide the desired current factors and voltage factors to the light source.

With the devices according to the invention it is possible not only to detect polarity, but, preferably also my means of values, for example tables or characteristic curves, which values are stored in a microprocessor, to detect the type of light source and its desired purpose of application, for example whether a light source is provided for illumination or whether it has a treatment function, for example polymerisation.

At this stage it should be pointed out that a special device or a special method provides for several readings to be carried out so that these readings can for example be compared to values stored in a microprocessor in order to ensure unambiguous allocation and identification of the light source connected or of a special instrument.

In a preferred embodiment subsequent readings are essentially identical, as described above, except that the current values and/or voltage values are different.

Normally a supply unit according to the invention is designed such that it can be connected to standard electrical power supplies, for example ranging from 220 to 230 volt at approximately 50 Hz for Europe, or approximately 100 to 110 volt at approximately 60 Hz for the USA.

At this stage it should be pointed out that the term “power supply unit” of the medical supply unit in the sense of this invention relates not only to a standard power source but also has to be interpreted in a wider sense and thus also includes an element, a component or module or a conductor, which essentially transmits onward the power that is supplied from an external source to the medical supply unit, while for example the medical supply unit at this position apart from electrical power also receives compressed air so that the corresponding power supplies (current and if applicable compressed air and/or other media) are supplied to the medical supply unit also from external sources, as is usually the case because as a rule the medical supply unit does not itself produce the power, for example using a generator, but instead is connected to at least one external power supply network, as explained above.

These and further characteristics of the present invention are clarified in further detail with reference to the drawings below which refer to preferred embodiments:

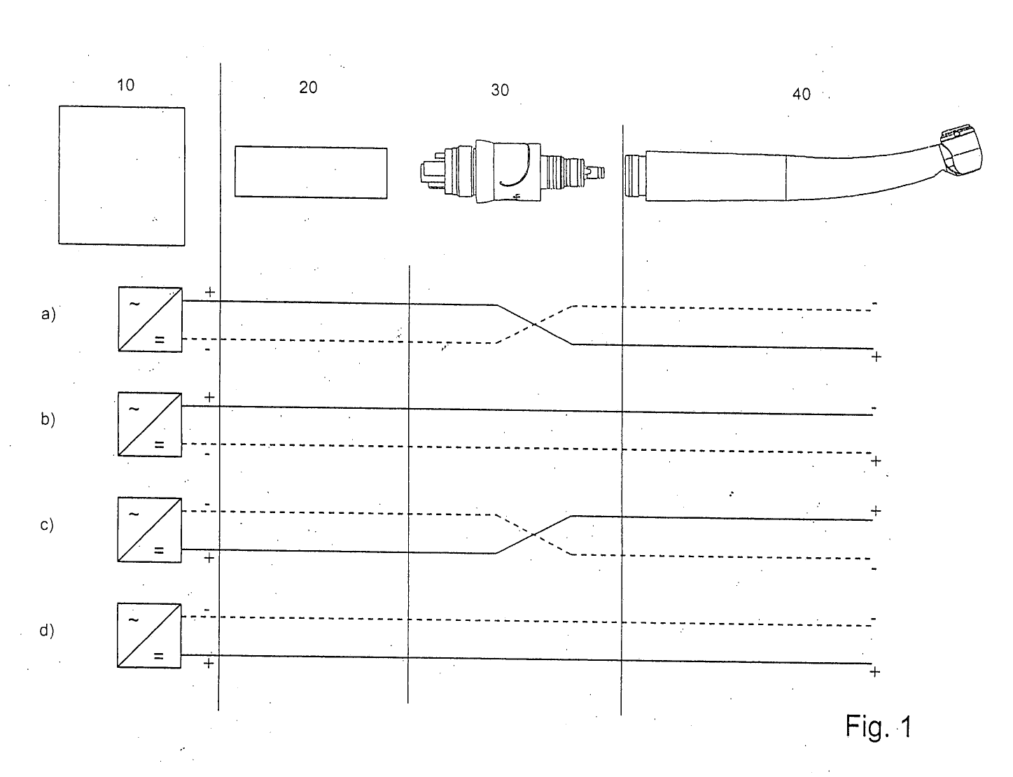

FIG. 1 diagrammatically shows a system according to the present invention;

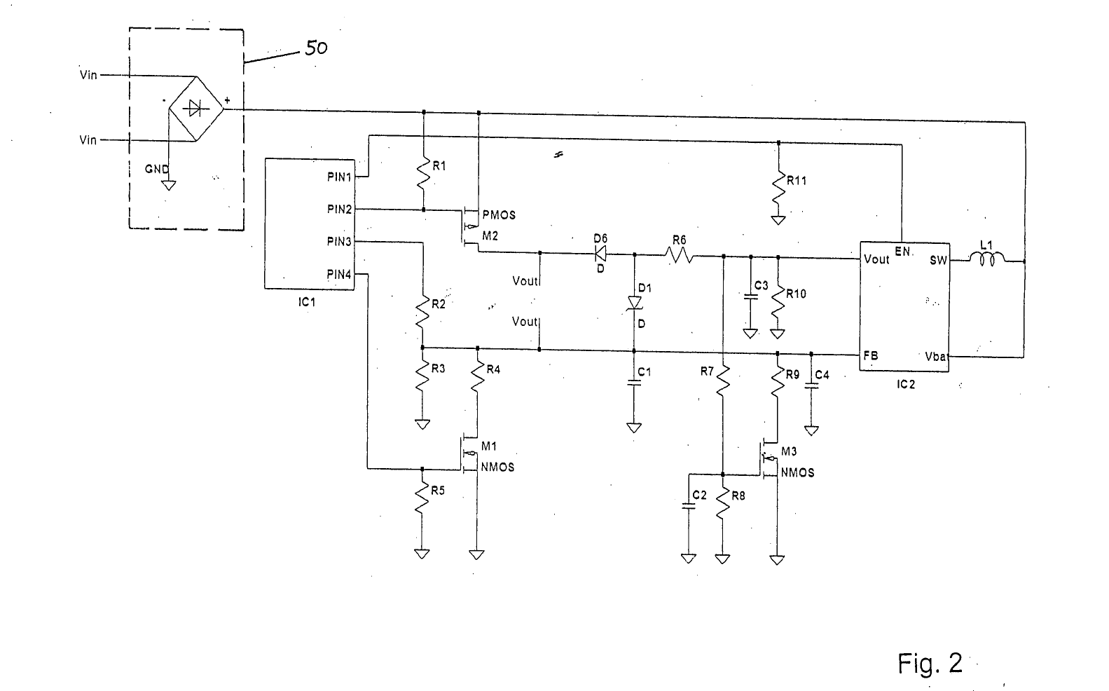

FIG. 2 shows a diagrammatic view of the electronics that are used in one embodiment of the present invention;

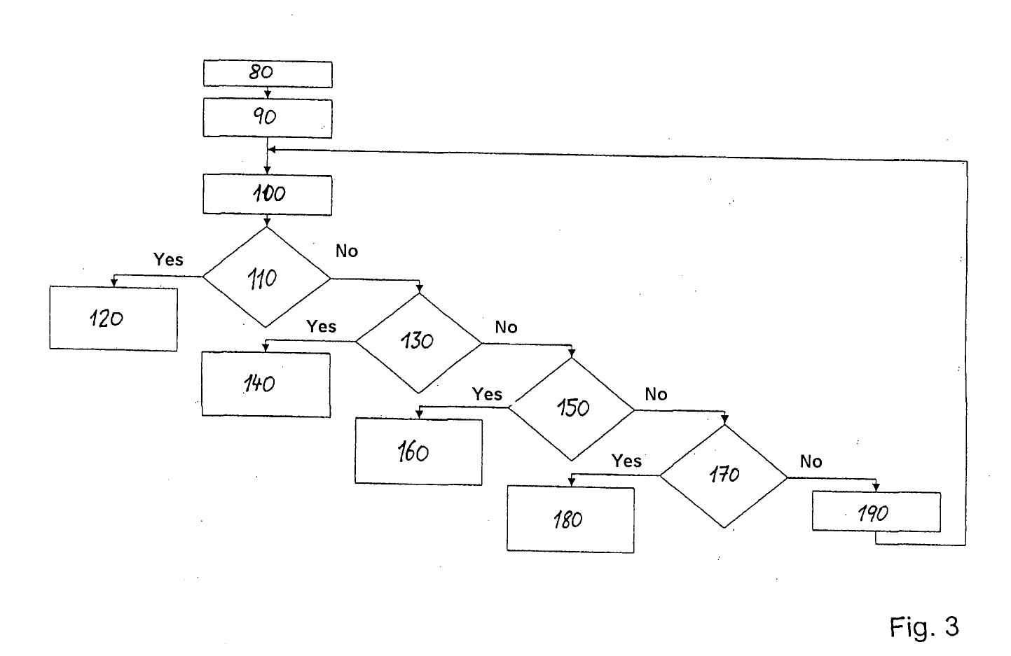

FIG. 3 shows a flow chart of a logic circuit that is used in one embodiment of the present invention; and

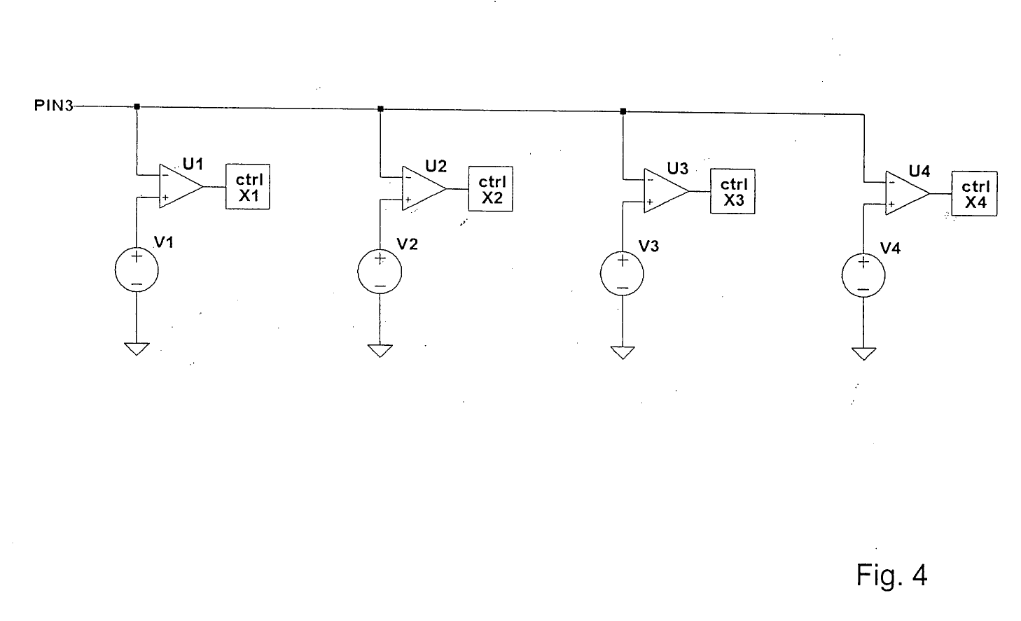

FIG. 4 shows part of the electronics that are used in a further embodiment of the present invention.

FIG. 1 diagrammatically shows one embodiment of an overall system according to the present invention, comprising a dental unit 10, a supply tube 20, an adapter 30 and a handpiece 40. In the embodiment shown in FIG. 1 the adapter 30 comprises the input circuit device, the output circuit device and the circuit device that is connected to the input circuit device and the output circuit device. In other embodiments according to the invention these elements can, however, also be provided in the supply unit 10 or in the handpiece 40.

FIG. 1 furthermore diagrammatically and merely by way of an example shows the possible combinations regarding the polarity of a light source that is provided in the handpiece 40, wherein the supply unit 10 is supplied with an alternating voltage which within the supply unit 10 is converted to a direct voltage of specified polarity.

This direct voltage with specified polarity is transmitted onward through the supply hose 20 to the adapter 30, wherein according to the invention the adapter checks not only the polarity of the power provided by the supply unit 10, but also the necessary polarity for the light source in the handpiece 40, wherein in those cases in which the polarity of the supply unit and the polarity of the light source agree, the polarity is not changed, as shown in cases a) and c), whereas in those cases where the polarity does not agree the circuit provided in the adapter 30 reverses the polarity, as diagrammatically shown in the cases b) and d).

FIG. 2 shows a diagrammatic view of the electronics according to a preferred embodiment, wherein input-side contact devices Vᵢₙ are provided for connection to the power supply of the supply unit. At this stage it should be pointed out that the contact devices can be connected, either directly or indirectly, i.e. with possible intermediary elements, for example a supply hose or similar, to the power supply of the supply unit. Normally the electrical contact is established by contacting contact; however it is also imaginable that proximity contacting is provided, for example by means of induction.

The electronics shown check not only the power supply, in particular the polarity, of the supply unit, but also the required power supply, in particular the polarity, for the light source, so that the handpiece to be connected is provided, by means of output-side contact devices Vₒᵤₜ, with a power supply that has the required characteristics.

The component designated 50 essentially comprises the input circuit device and in this embodiment is designed as a so-called bridge rectifier circuit that by way of the input-side contact devices Vᵢₙ can receive the power supply of the supply unit irrespective of the polarity. In this arrangement the bridge rectifier circuit is designed such that the power is transmitted onward in each case, except with fundamentally specified polarity. The cathode (negative pole) is also designated GND (ground) in the circuit diagram; a galvanic connection to it is indicated by a triangle standing on its tip.

On an output-side contact device Vₒᵤₜ the light-source circuit of the light source can be connected so that the required power is supplied to the light source.

The logic module IC1 is used to detect the type of polarity and if required the type of light source or instrument so that IC1 serves as an output circuit device. This logic circuit IC1 can be implemented by means of a microprocessor and corresponding software, or by pure hardware, i.e. logic modules, or it can be implemented by combinations thereof. The function of this logic circuit IC1 is in particular shown in the flow chart of FIG. 3.

The circuit, which is connected to the input- and output circuit device and is designed such that, based on the signals provided by the input- and output circuit device, it prepares the power supplied by the supply unit such that power with the required characteristics can be provided to the light-source circuit by way of the output-side contact device Vₒᵤₜ, comprises a DC/DC converter, see IC2, which converts a specified direct voltage to a direct voltage of some other type or intensity, for example by targeted selection of electrical power storage devices (coils, capacitors). However, the integrated circuit IC2 is only required if a LED or a light source is used that requires a specified polarity or a power supply that differs from that provided by the unit, wherein the IC2 is activated by way of the input EN (enable). The correct polarity of the electrical power is ensured by corresponding selection of the transistors M1 to M3.

If for example a miniature incandescent lamp is connected as a light source to the output-side contact devices Vₒᵤₜ, it is necessary to switch the power supplied by the supply unit directly to this output-side contact device Vₒᵤₜ and thus directly to the incandescent bulb. This is in turn ensured by driving the transistors M1 to M3. Differentiation between the individual illumination means as well as the selection of the integrated circuit IC2 and of the transistors M1 to M3, which selection is necessary for the respective illumination means, takes place by way of the logic circuit IC1, see in particular FIG. 3 and the associated explanations.

FIG. 3 is a diagrammatic representation, in the form of a flow chart, of a logic circuit according to a preferred embodiment for a handpiece with any desired light source. This logic circuit has preferably been implemented by means of software and a microprocessor, wherein the logic circuit after a possible “reset” 80 and selection of the transistors 90 in particular carries out a first reading or several readings on the load, namely on the handpiece to be connected, see step 100, in order to determine whether a light source requires a specific polarity, as is the case for example with a LED, and whether the power required for measuring is or is not switched in the direction of flow, see 110.

In those cases in which the light source (LED) during the test reading is switched in the direction of flow, the polarity can be maintained so that the integrated circuit IC2, see FIG. 2, and the transistors are selected for correct LED operation, see step 120.

If during the test reading the light source (LED) is in the direction of blockage, see 130, the polarity is reversed when compared to the polarity of the test readings so that the integrated circuit IC2, see FIG. 2, and the transistors are selected for correct LED operation, see step 140.

However, should the test readings show that no particular polarity is required and no direction of flow or direction of blockage can be defined, the system checks as to whether there is a miniature lamp in the handpiece, see 150, wherein if the result is positive, preferably by means of checking tables, data or characteristic curves stored on a microprocessor or corresponding storage devices, the transistors for correct operation of the lamp, for example an incandescent lamp, are selected, see step 160.

If the test readings indicate that none of the above-mentioned cases apply, it is assumed that a special instrument is involved, in particular a light source with an electronic circuit that belongs to the special instrument, which light source is not used for illumination but for example for curing light-curing plastic, wherein corresponding further test readings are carried out which are again preferably compared to corresponding data. If the test readings result in a particular special instrument being detected, see 170, the integrated circuit IC2, see FIG. 2, and the transistors for correct operation of this detected special instrument are selected, see step 180.

If the additional test readings do not lead to an unequivocal result, it is assumed that the readings were not successful, wherein the system then preferably carries out anew the various test readings, as described above, see step 190.

Preferably these steps can be carried out several times, wherein after a determined number of attempts, for example ten attempts, preferably an error code is issued.

In a particular embodiment, during step 110 for example a voltage of 1 V is applied and a current of for example 20 mA is measured. In respect of each possible illumination source, for example LED, incandescent lamp etc., a current-voltage curve or current-voltage table or similar is stored, and the electronics compare the pair of current/voltage measuring values (1 V, 20 mA) with each of these curves or each of the tables in a specified order, for example first with the values or tables that are allocated to the LED, for example first in the direction of flow, thereafter in the direction of blockage, thereafter with the curves or the values of an incandescent bulb etc., wherein preferably values for a special instrument are only checked after the specified possible illumination means have been checked.

As soon as the measured pair of values agrees with a point of one of these curves or with a value in a table, the type of the light source, the polarity and/or the special instrument is recognized.

If the pair of measured values cannot be allocated or at least cannot unequivocally be allocated, a second reading is carried out; in a particularly preferred embodiment at a different output voltage, for example 1.5 V.

It should be pointed out that a system according to the invention is designed such that the individual test readings can be supplemented and adapted in relation to possible further light sources—be it for illumination or in the case of so-called “special instruments”—for example by means of new software, input of additional data and/or characteristic curves on a memory which a microprocessor can access, or by the use of new logic modules.

FIG. 4 shows part of a region of electronics as can be used in a further embodiment of the invention, wherein the partial region shown in FIG. 4 is in particular used to detect the type of the light source and/or of the light-source circuit or of the special instrument.

The components designated V1 to V4 in FIG. 4 represent reference voltage sources that provide such voltages that correspond to selected characteristic voltages of possible illumination means or illumination sources and/or light-source circuits. These voltage sources can for example be implemented with the use of standard components, or for example the standard component LM317.

The components designated U1 to U4 in FIG. 4 represent comparators which compare the voltage of the respective reference voltage sources V1 to V4 with the voltage that is also present at PIN3. In this arrangement the comparators are designed in such a way that if these two voltages agree, i.e. if the applied voltages are identical, a logical high signal is provided at the output, wherein this signal is forwarded to corresponding selection circuits, which in FIG. 4 are designated ctrlX1 to ctrlX4.

By means of such an arrangement of reference voltage sources V1 to V4, with the use of the comparators U1 to U4, the illumination means or the light source and/or the light-source circuit can be identified, wherein the selection circuits ctrlX1 to ctrlX2 select the transistors M1 to M3 (see FIG. 2) as well as the DC/DC converter IC2 (see also FIG. 2) such that the power that is required for proper operation of the light source or of the light-source circuit and the associated illumination means is conveyed to the illumination means.

The characteristics disclosed in the above description, in the claims and in the drawings can be significant both individually and in any desired combination for implementing the various embodiments of the invention.

1. An adapter for a medical handpiece (40), by way of which adapter the power suppliable by a power supply unit can be fed to the handpiece (40), wherein the adapter comprises:
an input-side contact device (Vᵢₙ) for connection to the power supply of the supply unit;
an input circuit device, communicating with the input-side contact device, for detecting the type of the power supply provided by the supply unit;
an output-side contact device (Vₒᵤₜ) for connection to a light-source circuit of a light source of the medical handpiece;
an output circuit device, communicating with the output-side contact device (Vₒᵤₜ) for detecting the type of the light source and/or the type of the light-source circuit; and
a circuit that is connected to the input circuit device and the output circuit device and is designed such that, based on the signals provided by the input circuit device and the output circuit device, said circuit prepares the power supply provided by the supply unit in such a way that power with the required characteristics can be supplied to the light-source circuit of the medical handpiece by way of the output-side contact device (Vₒᵤₜ).

2. The adapter according to claim 1, characterised in that the circuit comprises a logic circuit (IC1).

3. The adapter according to claim 2, characterised in that the logic circuit (IC1) has at least in part been implemented by a microprocessor and software.

4. The adapter according to claim 2, characterised in that the logic circuit (IC1) has at least in part been implemented by logic modules.

5. The adapter according to claim 1, characterised in that the circuit comprises a DC/DC converter.

6. The adapter according to claim 5, characterised in that the circuit comprises a step-up converter.

7. A medical handpiece (40) with a light source and an associated light-source circuit, comprising:
an input-side contact device (Vᵢₙ) for connection to the power supply of the supply unit;
an input circuit device, communicating with the input-side contact device (Vᵢₙ), for detecting the type of the power supply provided by the supply unit;
a circuit that is connected to the input circuit device and is designed such that, based on the signals provided by the input circuit device, said circuit prepares the power supply provided by the supply unit in such a way that power with the required characteristics can be supplied to the light-source circuit of the medical handpiece.

8. The medical handpiece according to claim 7, characterised in that the circuit comprises a logic circuit (IC1).

9. The medical handpiece according to claim 8, characterised in that the logic circuit (IC1) has at least in part been implemented by a microprocessor and software.

10. The medical handpiece according to claim 8, characterised in that the logic circuit (IC1) has at least in part been implemented by logic modules.

11. The medical handpiece according to claim 7, characterised in that the logic circuit comprises a DC/DC converter.

12. The medical handpiece according to claim 11, characterised in that the logic circuit comprises a step-up converter.

13. The medical handpiece according to claim 7, characterised in that as a light source it comprises at least one LED.

14. The medical handpiece according to claim 7, characterised in that as a light source it comprises at least one incandescent lamp.

15. The medical handpiece according to claim 7, characterised in that as a light source it comprises at least one gas discharge lamp.

16. A medical supply unit (10) to which at least one medical handpiece (40) is connectable, comprising:
a power supply unit;
an output-side contact device for connection to a light-source circuit of a light source of a medical handpiece;
an output circuit device that communicates with the output-side contact device, for detecting the type of the light source and/or of the light-source circuit; and
a circuit that is connected to the output circuit device and is designed such that, based on the signals provided by the output circuit device, said circuit prepares the power supplied by the supply unit such that power with the required characteristics can be provided to the light-source circuit of the at least one medical handpiece by way of the output-side contact device.

17. The medical supply unit according to claim 16, characterised in that the circuit comprises a logic circuit (IC1).

18. The medical supply unit according to claim 17, characterised in that the logic circuit (IC1) has at least in part been implemented by a microprocessor and software.

19. The medical supply unit according to claim 17, characterised in that the logic circuit (IC1) has at least in part been implemented by logic modules.

20. The medical supply unit according to claim 16, characterised in that the circuit comprises a DC/DC converter.

21. The medical supply unit according to claim 20, characterised in that the circuit comprises a step-up converter.

22. The medical supply unit according to claim 16, characterised in that it comprises several circuits, which are independent of each other, for parallel connection of at least two medical handpieces.

23. A method for preparing a power supply, provided by a supply unit (10), for a light-source circuit of a light source of a medical handpiece (40), comprising the following steps:
a) checking the type of the power supply provided by the supply unit;
b) checking the type of the light source and/or the type of the light-source circuit of the medical handpiece (40);
c) automatic preparation of the power supply provided by the supply unit (10) by means of a circuit depending on the results of steps a) and b).

24. The method according to claim 23, characterised in that preparation takes place at least in part by means of software.

25. The method according to claim 23, characterised in that preparation takes place at least in part by means of logic modules.
